(19) United States
(12) Patent Application Publication
(10) Pub. No.: US 2011/0293210 A1
(43) Pub. Date: Dec. 1, 2011

(54) CENTRIFUGAL VARIABLE PRELOAD DEVICE

(76) Inventor: Michael T. Fournier, Howell, MI (US)

(21) Appl. No.: 12/788,889

(22) Filed: May 27, 2010

(51) Int. Cl. F16C 41/00

(52) U.S. Cl. 384/447

(57) ABSTRACT

According to at least one exemplary embodiment, a variable preload device is disclosed. The variable preload device may include at least two annular end members, each annular member adapted to receive a shaft therein, and a plurality of plates axially extending between the annular end members and hingedly coupled thereto. The plurality of plates may be adapted to bend inward so as to impart an hourglass configuration to the variable preload device when the variable preload device is at rest and to bend outward in proportion to increased rotational speed provided to the variable preload device. Furthermore, the axial distance between the annular end members may varies in proportion to the rotational speed provided to the variable preload device.

### BACKGROUND

Bearing devices, namely rolling-element bearings, are typically used to support a rotating shaft or spindle within a housing. Such bearings include an outer race coupled to the housing, an inner race coupled to the shaft, and a plurality of rolling elements disposed between and in contact with both races. The motion of the bearing components relative to each other allows the shaft to rotate within the housing while minimizing friction and resistance to rotation. Typically, bearings are assembled such that there exists a small internal clearance between the rolling elements and the inner and outer races during operation.

In certain situations, it may be desirable to preload the bearing, i.e., to remove the internal clearance in the bearing and to introduce a negative internal clearance. Bearing preload is commonly introduced by the application of a permanent axial load to at least one a race of the bearing such that the two bearing races are displaced in the axial direction relative to each other. The result is a constant elastic compressive force being applied to the points of contact between the rolling elements and the two races. The internal stress thus generated in turn results in increased stiffness and rigidity, reduction in radial and axial free-play, reduction in vibration, and increase in rotating precision.

The desired amount of preload may vary with the intended rotational speed range of the shaft to which the bearing is coupled. High bearing preloads are generally suitable for low rotational speeds; however, at high rotational speeds, high preloads result in the increase of frictional forces and the generation of excessive heat, which, in turn, reduces bearing life and may result in bearing failure. It is therefore desirable to lessen the preload for bearings that are expected to operate at high rotational speeds, and to increase the preload for bearings that are expected to operate at low rotational speeds. For machinery capable of operating at both high and low rotational speeds, it becomes desirable to dynamically and automatically alter the bearing preload during operation so that the preload is optimally correlated to the rotational speed. It is further desirable to dynamically and automatically alter bearing preload while minimizing the amount of and complexity of components and logic necessary therefor.

### SUMMARY

According to at least one exemplary embodiment, a variable preload device is disclosed. The variable preload device may include at least two annular end members, each annular member adapted to receive a shaft therein, and a plurality of plates axially extending between the annular end members and hingedly coupled thereto. The plurality of plates may be adapted to bend inward so as to impart an hourglass configuration to the variable preload device when the variable preload device is at rest and to bend outward in proportion to increased rotational speed provided to the variable preload device. Furthermore, the axial distance between the annular end members may vary in proportion to the rotational speed provided to the variable preload device.

According to another exemplary embodiment, a rolling-element bearing assembly is disclosed. The assembly may include a housing, a spindle arbor, at least two bearings each having an inner race keyed to the spindle arbor and an outer race keyed to the housing, at least two end plates keyed to the spindle arbor, each end plate operatively coupled to an inner race of one of the at least two bearings, a variable preload device substantially concentric with, surrounding, and keyed to the spindle arbor, and extending between the at least two end plates and operatively coupled thereto, and an opposing spring force acting on an inner race of at least one of the at least two bearings. The variable preload device of the rolling-element bearing assembly may exert an axial force on an inner race of a bearing, the axial force acting in opposition to the opposing spring force and having a magnitude proportional to the rotational speed of the spindle arbor, so as to increase the internal clearance of the bearing.

### BRIEF DESCRIPTION OF THE FIGURES

FIG. 1a is a side view of an exemplary embodiment of a centrifugal variable preload device.

FIG. 1b is an end view of an exemplary embodiment of a centrifugal variable preload device.

FIG. 2a shows an exemplary embodiment of a centrifugal variable preload device in a low-speed configuration.

FIG. 2b shows an exemplary embodiment of a centrifugal variable preload device in a high-speed configuration.

FIG. 3a is a cross-section of exemplary embodiment of a centrifugal variable preload device in a typical operative environment under low-speed conditions.

FIG. 3b is a detail of FIG. 3a showing a high-preload configuration.

FIG. 4a is a cross-section of exemplary embodiment of a centrifugal variable preload device in a typical operative environment under high-speed conditions.

FIG. 4b is a detail of FIG. 4a showing a low-preload configuration.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiment are not necessarily to be construed as preferred or advantageous over other embodiments. Moreover, the terms “embodiments of the invention”, “embodiments” or “invention” do not require that all embodiments of the invention include the discussed feature, advantage or mode of operation.

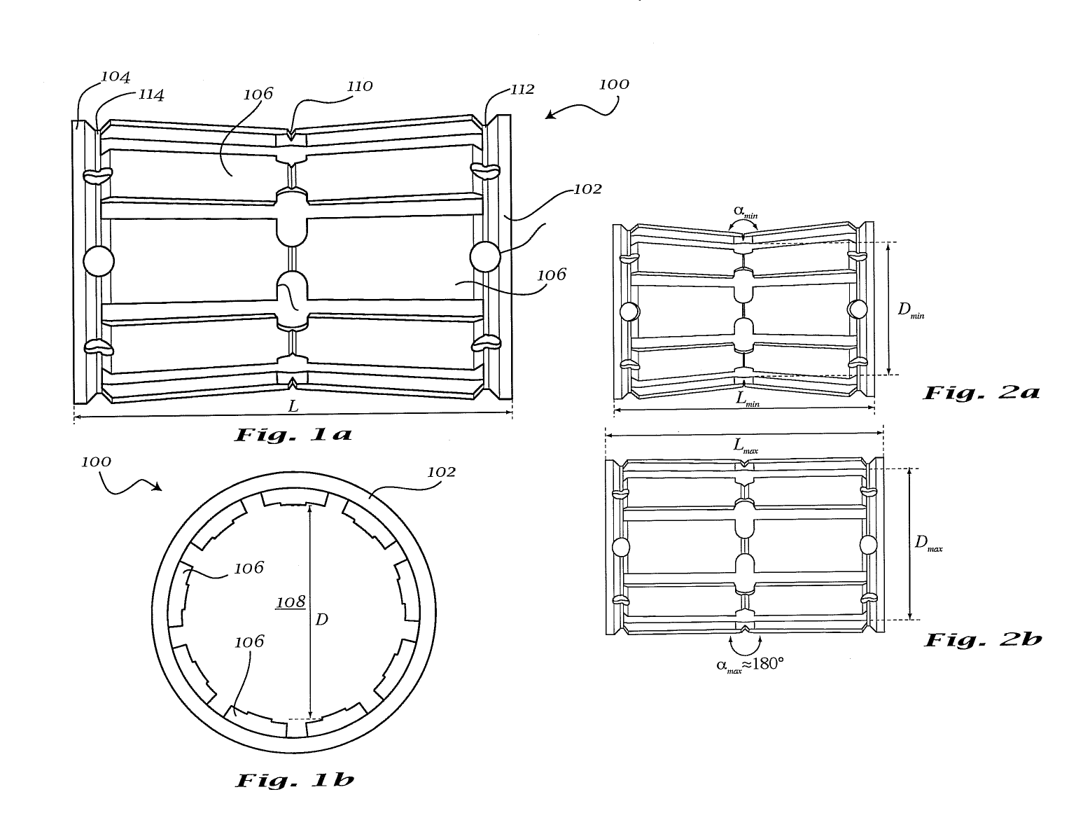

FIGS. 1a-1b show an exemplary embodiment of a centrifugal variable preload device 100. Variable preload device 100 may include a first annular end member 102, a second annular end member 104, and a plurality of plates 106 extending therebetween. Each plate 106 may have a first end coupled to first annular end member 102 and a second end coupled to second annular end member 104, thereby defining a cylindrical inner cavity 108 which may be capable of receiving a spindle arbor.

Each plate 106 may include a central groove 110 defined therein. Central groove 110 may be disposed at the midpoint of the longitudinal axis of plate 106 and may be situated perpendicular to said longitudinal axis. Central groove 110 may have a depth and profile that facilitate the bending of plate 106 between a linear configuration and an angled configuration, wherein central groove 110 may be the vertex of the resultant angle α. Variable preload device 100 may further include a first circumferential groove 112 and a second circumferential groove 114. First circumferential groove 112 may be disposed proximate to first annular end member 102. Second circumferential groove 114 may be disposed proximate to second annular end member 104. Each of circumferential grooves 112, 114 may have a depth and profile that facilitate changing the angle of a plate 106 relative to the corresponding annular end member 102, 104 by allowing for flexing at the grooves. It should be appreciated that grooves 110, 112, 114 facilitate transforming the shape of variable preload device 100 between an hourglass configuration, as shown in FIG. 2a, and a cylindrical configuration, as shown in FIG. 2b, and thereby altering the length and inner diameter D of variable preload device 100.

In some embodiments, variable preload device 100 may be formed from a unitary piece of a material that allows device 100 to function as described herein. Such a material may be any material known in the art that is capable of resisting fatigue at flex joints such as grooves 110, 112, 114. For example, variable preload device 100 may be formed from a high-stiffness, low-friction and fatigue-resistant material, such as polyoxymethylene. In other embodiments, variable preload device may be formed from nylon, spring steel, or other materials having similar properties. In other embodiments, variable preload device may be formed from a combination of materials selected so as to impart device 100 with the desired characteristics. In such embodiments, the flex joints of device 100, i.e. parts of device 100 proximate to grooves 110, 112, 114, may be formed from a different material than the other components of device 100, and coupled with the other components of device 100 via adhesion, fusion, or any other desired coupling that enables device 100 to function as described herein.

Further referring to FIGS. 2a-2b, the length L of centrifugal variable preload device 100 may vary in relation to the configuration of variable preload device 100. When variable preload device 100 is in an hourglass configuration, angle α may be equal to a minimum angle αₕ. Minimum angle αₘᵢₙ may be any desired value that enables variable preload device 100 to function as described herein, and may be varied as desired. For example, minimum angle αₘᵢₙ. may be varied by altering the profile of central groove 110 such that contact between the side walls of central groove 110 impedes bending of a plate 106 beyond the desired angle. In other embodiments, such bending of plate 106 may be impeded by contact between the inner surface of a plate 106 and the surface of a spindle arbor over which variable preload device 100 may be fitted. When α=αₘᵢₙ, the length L of variable preload device 100 may likewise be equal to minimum length Lₘᵢₙ and inner diameter D of variable preload device 100 may likewise be equal to minimum inner diameter Dₘᵢₙ. Thus, a desired angle αₘᵢₙ may be chosen based on a desired minimum length Lₘᵢₙ, on a desired minimum inner diameter Dₘᵢₙ (which can be based on the diameter of the spindle arbor passing through inner cavity 108) or any other desired considerations or combination thereof.

Imparting rotational motion to variable preload device 100 can generate a resultant centrifugal force that increase in relation with increasing rotational speed. The application of such centripetal force to variable preload device 100 may then result in the reduction in the bending of plates 106 as the vertices thereof, which are disposed along central groove 110, may be induced to move outward from the longitudinal axis of variable preload device 100. That is, angle α increases proportionally with the rotational speed of variable preload device 100, and, due to the configuration of variable preload device 100, length L increases proportionally with the increase of angle α. Thus, ΔL=kω=k′F, where ΔL is the change in length, ω is the rotational speed imparted to variable preload device 100, F is the resultant centrifugal force action on variable preload device 100, and k, k′ are proportionality constants that are representative of the physical properties of variable preload device 100. The values of proportionality constants k, k′ may be varied by altering the physical properties of variable preload device 100.

Varying the physical properties of variable preload device 100 allows for the tuning of variable preload device 100 such that it is optimized for a desired application or a desired range of operating speeds and such that it achieves the desired amount of preload. Such physical properties may include, but not limited to, the density of the material from which variable preload device 100 is formed, the weight of variable preload device 100 and the distribution of mass therethrough, the length and diameter of variable preload device 100, and the resistance to bending of grooves 110, 112, 114. Such resistance to bending may further be varied as desired by altering the lengths of grooves 110, 112, 114. In some embodiments, variable preload device 100 may include a plurality of apertures 116 and cutouts 118. Apertures 116 and cutouts 118 may be defined such that they are disposed along grooves 110, 112, 114, thereby effectively lessening the length of grooves 110, 112, 114 and consequently reducing the rigidity and resistance to bending thereof. The dimensions of apertures 116 and cutouts 118 may be altered during or after manufacture of variable preload device 100, thereby allowing variable preload device 100 to be easily optimized for a desired operating range.

Variable preload device 100 may also be tuned by the addition of mass to device 100. For example, inserts or weights (not shown) may be added to plates 106 to increase the mass of plates 106. Such weights or inserts may be constructed of materials having various densities, such that the weights or inserts may have a substantially similar size or configuration while having varying mass. For example, the materials for the weights or inserts may be formed from plastics, polymers, metals, and so forth. The weights or inserts may then be coupled to plates 106 by mechanical coupling such as pins or rivets, or by adhesion. In some embodiments, the weights or inserts may be formed as pins, rivets, or other mechanical coupling structures.

As rotational speed of variable preload device 100 increases, angle α can approach a maximum value αₘₐₓ of about 180°, and may result in the halves of each plate 106 being substantially coplanar. When α=αₘₐₓ, the length L of variable preload device 100 may likewise be equal to maximum length Lₘₐₓ and variable preload device 100 may have a generally cylindrical configuration. As variable preload device 100 approaches the cylindrical configuration, it furthermore becomes more resistant to axial counterforces exerted thereon when variable preload device 100 is operatively coupled to a bearing or bearings, as described below.

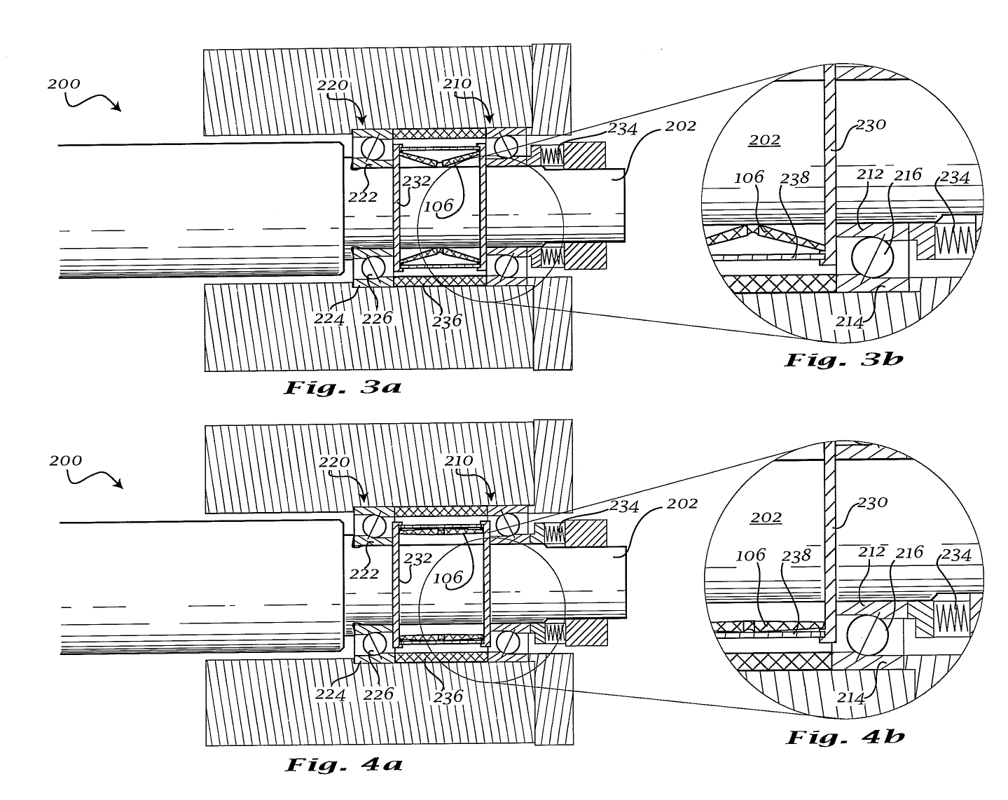

FIGS. 3a-4b illustrate an exemplary embodiment of a shaft-supporting apparatus 200, wherein centrifugal variable preload device 100 may be fitted, keyed, or otherwise coupled to an exemplary spindle arbor 202 such that the rotational speed of spindle arbor 202 is imparted to variable preload device 100. Variable preload device 100 may further be operatively coupled to exemplary first and second rolling-element bearings 210, 220. First rolling-element bearing 210 may include an inner race 212, an outer race 214, and rolling elements 216. Similarly, second rolling-element bearing 220 may include an inner race 222, an outer race 224, and rolling elements 226. Variable preload device 100 may further include first and second end plates 230, 232 and be disposed therebetween. In turn, first end plate 230 may be coupled to first rolling-element bearing 210 and second end plate 232 may be coupled to second rolling-element bearing 220.

Apparatus 200 may further include at least one opposing spring force 234 applied to an inner race 212, 222 of at least one of bearings 210, 220, thereby providing a constant preload to the at least one bearing. The preload force applied to the inner race of one bearing may be transferred via end plates 230, 232 and via variable preload device 100 to the inner race of the complementary bearing. Apparatus 200 may further include a conventional bearing spacer 236 disposed between the outer races 214, 224 of bearings 210, 220, thereby maintaining a desired spacing therebetween.

In some embodiments, variable preload device 100 may further include an outer cylinder 238 disposed between end plates 230, 232. Cylinder 238 may have a diameter greater than the diameter of variable preload device 100 and may have a cavity therein for receiving variable preload device 100. The diameter of cylinder 238 may further be configured such that it provides a contact surface for transverse plates 100 when α=αₘₐₓ, thereby reducing the likelihood of variable preload device 100 adopting a convex configuration at high rotational speeds. Furthermore, in some embodiments, cylinder 238 may have a length that is greater than minimum length Lₘᵢₙ of variable preload device 100. In such embodiments, cylinder 238 impedes end plates 230, 232 from contracting past the length of cylinder 238. Consequently, the length of cylinder 238 may define an effective minimum length Lₘᵢₙ for variable preload device 100. It should thus be appreciated that the length of cylinder 238 may be adjusted to obtain a desired preload value when variable preload device is at rest or operating at low speeds.

FIGS. 3a-3b show apparatus 200 at low rotational speed ranges, where high bearing preload is generally desirable. At such speeds, variable preload device 100 may be an hourglass configuration with plates 106 in contact with spindle arbor 202 and length L approaching minimum length Lₘᵢₙ. Bearings 210, 220 may be preloaded by opposing spring force 234, which may be applied, for example, to the inner race 212 of first bearing 210. The preload force may be distributed to the inner race 222 of second bearing 220 via endplates 230, 232, cylinder 238, and variable preload device 100; thus, the preloading force may be substantially evenly split between bearings 210, 220.

FIG. 4a-4b show apparatus 200 at high rotational speed ranges, where low bearing preload is generally desirable. At such speeds, variable preload device 100 may be in a cylindrical configuration with plates 106 in contact with outer cylinder 238 and length L approaching maximum length Lₘₐₓ. The increase in length L of variable preload device 100 results in an application and even distribution of axial force via end plates 230, 232 to the inner races 212, 222 of bearings 210, 220. The resultant axial force may be applied counter to opposing spring force 238. Consequently, the inner races 212, 222 of bearings 210, 230 may be axially displaced, as shown in detail in FIG. 4b, thereby lessening the preload of bearings 210, 220. As the change in length L is proportional to the rotational speed of spindle arbor 202, the use of variable bearing device 100 may facilitate dynamically and progressively reducing the preload of bearings 210, 220 with increased rotational speed, thereby providing an optimal bearing preload force across a wide range of rotational speeds.

It should be noted that at high rotational speed ranges, as length L increases beyond the length of outer cylinder 238, a gap 239 may result between cylinder 238 and end plates 230, 232. In certain situations, the presence of gap 239 may result in outer cylinder 238 floating axially between plates 230, 232, which in turn may result in rattling and vibration. Therefore, in some embodiments, dampeners, for example, o-rings, may be disposed between the edges of cylinder 238 and end plates 230, 232, thereby providing axial centering to cylinder 238 and reducing gap 239 such that rattling and vibration is minimized. The dampeners may by formed of a resiliently compressible material that compresses sufficiently at low rotational speed ranges to allow variable preload device 100 to function as described herein.

In some embodiments, first and second annular end members 102, 104 may interface with end plates 230, 232 via a tongue-and-groove interface. First and second annular end members 102, 104 may have a convex profile, and may be received within a concave groove defined in end plates 230, 232. Such a configuration may serve to minimize wear on the components at the interface points. Furthermore, end plates 230, 232, variable preload device 100, and spindle arbor 202 may incorporate anti-slip features to facilitate maintaining synchronous rotation of such components over the range of rotational speeds. Such anti-slip features may include, but are not limited to, O-rings, pins, and keying of the components to each other.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A variable preload device, comprising:
at least two annular end members, each annular member adapted to receive a shaft therein; and
a plurality of plates axially extending between the annular end members and hingedly coupled thereto, each plate further comprising a transverse groove defined therein, the groove adapted to facilitate bending of the plate about the groove.

2. The variable preload device of claim 1, wherein:
the plurality of plates are adapted to bend inward so as to impart an hourglass configuration to the variable preload device when the variable preload device is at rest; and
the plurality of plates are adapted to bend outward in proportion to increased rotational speed provided to the variable preload device.

3. The variable preload device of claim 2, wherein the axial distance between the annular end members varies in proportion to the rotational speed provided to the variable preload device.

4. The variable preload device of claim 3, wherein said proportion may be varied as desired.

5. The variable preload device of claim 4, wherein said proportion may be varied by adjusting the length and depth of the transverse groove.

6. The variable preload device of claim 4, wherein said proportion may be varied by adjusting the mass of the plates.

7. A variable preload device, comprising:
at least two annular end members; and
a plurality of plates axially extending between the annular end members, each plate further comprising two portions and a hinge defined therebetween, the hinge adapted to allow the plates to bend inward so as to define an angle between the two portions, the angle varying in proportion to the rotational speed of the variable preload device.

8. The variable preload device of claim 7, wherein distance between the annular members varies in proportion to the angle between the two portions.

9. The variable preload device of claim 8, wherein said proportion may be varied as desired.

10. The variable preload device of claim 8, wherein said proportion may be varied by adjusting the length and depth of the hinge.

11. The variable preload device of claim 4, wherein said proportion may be varied by adjusting the mass of the plates.

12. A rolling-element bearing assembly, comprising:
a housing;
a spindle arbor;
at least two bearings, each bearing having an inner race keyed to the spindle arbor and an outer race keyed to the housing;
at least two end plates keyed to the spindle arbor, each end plate operatively coupled to an inner race of one of the at least two bearings;
a variable preload device substantially concentric with, surrounding, and keyed to the spindle arbor, the variable preload device extending between the at least two end plates and operatively coupled thereto; and
an opposing spring force acting on an inner race of at least one of the at least two bearings.

13. The rolling-element bearing assembly of claim 12, wherein the variable preload device further comprises at least two annular end members and a plurality of plates extending therebetween, the plates bending inward about a hinge when at rest and bending outward in proportion to the rotational speed of the spindle arbor so as to increase the axial distance between the at least two annular end members.

14. The rolling-element bearing assembly of claim 13, wherein the variable preload device exerts an axial force on an inner race of at least one of the at least two bearings, the axial force acting in opposition to the opposing spring force and having a magnitude proportional to the rotational speed of the spindle arbor, so as to increase the internal clearance of the bearing.

15. The rolling-element bearing assembly of claim 14, wherein the variable preload device exerts an axial force on an inner races of the at least two bearings via the at least two end plates.

16. The rolling-element bearing assembly of claim 14, wherein the axial force is distributed evenly among the at least two bearings.

17. The rolling-element bearing assembly of claim 12, further comprising a cylinder substantially concentric with and surrounding the variable preload device.

18. A variable preload device adapted to receive a spindle arbor therein and having a length, the length being variable in proportion to the rotational speed of the spindle arbor.

19. The variable preload device of claim 18, wherein the variable preload device is disposed between a pair of bearings and exerts a preload force on the bearings.

20. The variable preload device of claim 19, wherein the preload force varies in inverse proportion to the length of the variable preload device.
